(19) United States
(12) Patent Application Publication
(10) Pub. No.: US 2008/0236989 A1
(43) Pub. Date: Oct. 2, 2008

(54) Banknote Identification Apparatus

(75) Inventors: Takashi KONDOU, Ashikaga-shi (JP); Koji IWAI, Isesaki-shi (JP); Hiroshi KATOU, Isesaki-shi (JP); Hironobu KUROSAWA, Isesaki-shi (JP); Atsuhiro TADENUMA, Ashikaga-shi (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Isesaki-shi (JP)

(21) Appl. No.: 12/038,909

(22) Filed: Feb. 28, 2008

(30) Foreign Application Priority Data
Mar. 29, 2007 (JP) 2007-089237

(51) Int. Cl. G07F 7/04

(52) U.S. Cl. 194/206

(57) ABSTRACT

There is provided with a check control unit which executes check operations selected by selection switches and a rear chute opening/closing detection sensor based on detection results of insertion detecting sensors and at least one of turn-on and turn-off of a check button when it is judged that predetermined check operations can be done based on the detection result of an storage cassette opening/closing detection sensor.

### BACKGROUND OF THE INVENTION

(i) Field of the Invention

The present invention relates to a banknote identification apparatus, which is installed, for example, in a vending machine, and identifies and stores authenticity of banknotes inserted in a banknote insertion slot.

(ii) Description of the Related Art

Conventionally, an apparatus which measures the length of banknotes delivered by a banknote delivery mechanism, compares it with an upper limit value of a tolerance of the length of the banknotes, monitors a number that the measured length of the banknote exceeds the stored upper limit, judges that slippage of the banknotes occurs due to the dirt of the banknote delivery mechanism when the number exceeds a predetermined number, and notifies a maintenance timing of the banknote identification apparatus, has been known as this kind of banknote identification apparatus (for example, see Japanese Patent Publication No. 2002-150362).

Meanwhile, in an operation for checking the banknote identification apparatus, predetermined checking operations are verified to check whether the operation of the banknote identification apparatus is normal or not. However, a conventional banknote identification apparatus cannot check arbitrary operations to be checked unless it is connected with, for example, a machine like a personal computer. So, the checking operations cannot be verified only by the banknote identification apparatus alone, which might lead to complicated checking operations.

### BRIEF SUMMARY OF THE INVENTION

In view of the above-mentioned problem, an object of the present invention is to provide a banknote identification apparatus whose checking operation can be easily done.

To achieve the above-mentioned object, the present invention proposes a banknote identification apparatus comprising a banknote delivery mechanism which delivers banknotes inserted in a banknote insertion slot, a banknote identification mechanism for judging authenticity of the banknotes, a unit body including at least the banknote delivery mechanism and the banknote identification mechanism, a banknote storage cassette for storing the banknotes delivered by the banknote delivery mechanism, a judgment means for judging whether predetermined checking operations can be done or not, a selection means for selecting one of the checking operation among the predetermined checking operations, and a check means for performing the check operation selected by the selection means when it is judged that the predetermined checking operations can be done by the judgment means.

According to the present invention, because the selected check operation is done when it is judged that the predetermined checking operations can be done, there is no need of other machines in the check operation and the selected check operation can be done. Therefore, the arbitrarily selected check operation can be verified, and the check operation can be made easily.

The above-mentioned and other objects, characteristics and advantages of the present invention will become apparent with reference to following explanation and attached drawings.

### BRIEF DESCRIPTION OF SEVERAL VIEWS OF THE DRAWINGS

FIG. 1 is a front perspective view of a banknote identification apparatus;

FIG. 2 is a rear perspective view of the banknote identification apparatus shown in FIG. 1;

FIG. 3 is a side section view of the banknote identification apparatus shown in FIGS. 1 and 2;

FIG. 4 is an enlarged view of a main part of FIG. 3;

FIG. 5 is a diagram showing a control system for checking the banknote identification apparatus;

FIG. 6 is a flow chart explaining actions for checking the banknote identification apparatus;

FIG. 7 is a constitution view of the checking operation shown in FIG. 6;

FIG. 8 is a flow chart explaining a belt checking processing shown in FIG. 7;

FIG. 9 is a flow chart explaining an storage checking processing shown in FIG. 7;

FIG. 10 is a flow chart explaining a banknote return checking processing shown in FIG. 7;

FIG. 11 is a flow chart explaining banknote storage checking processing shown in FIG. 7; and

FIG. 12 is a flow chart explaining a shutter checking processing shown in FIG. 7.

### DETAILED DESCRIPTION OF THE INVENTION

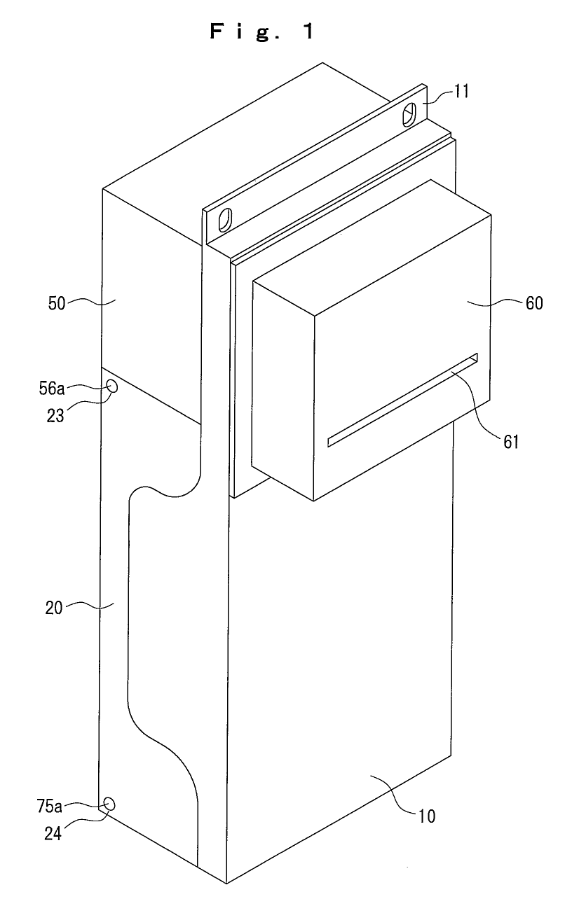

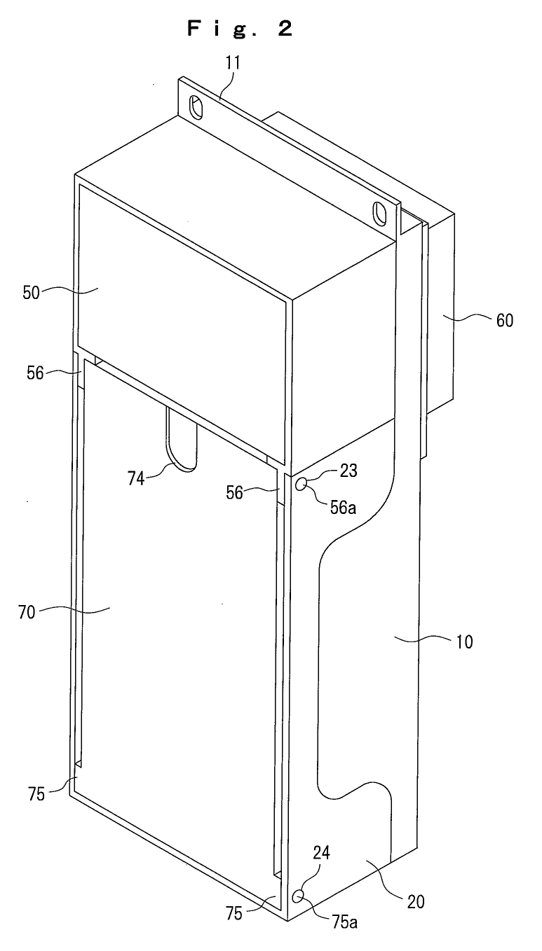

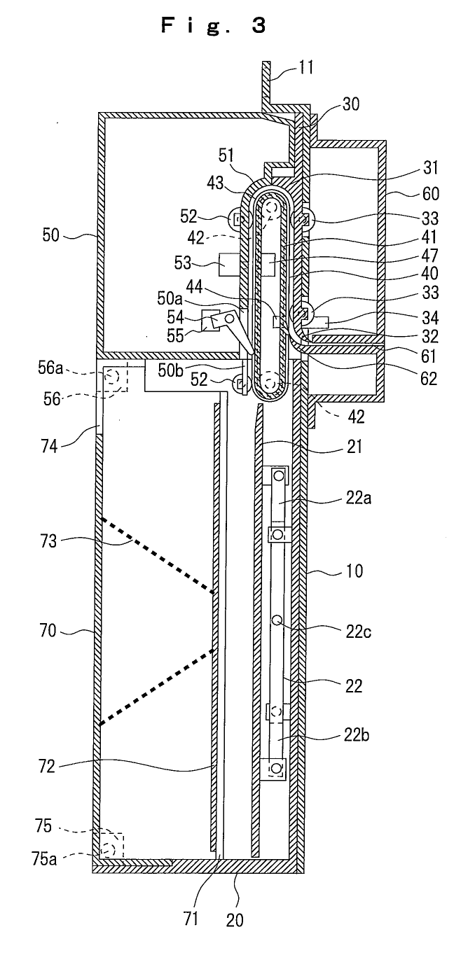

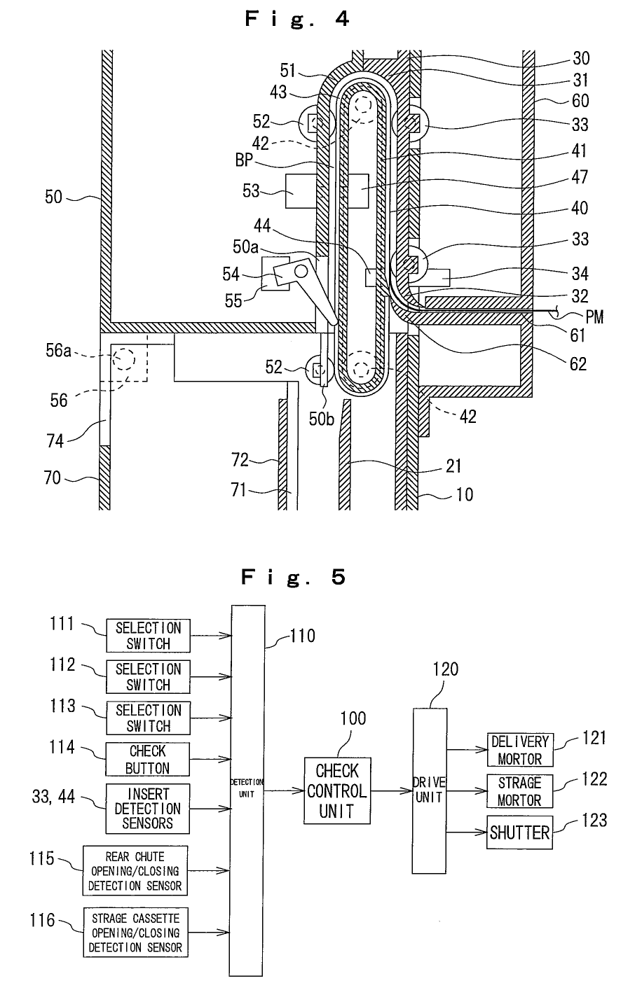

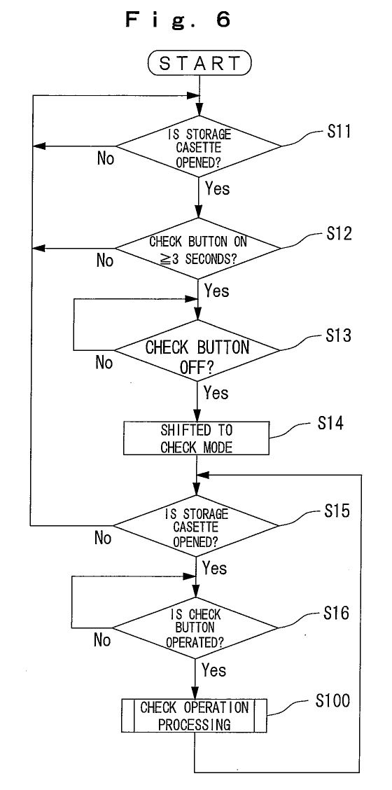

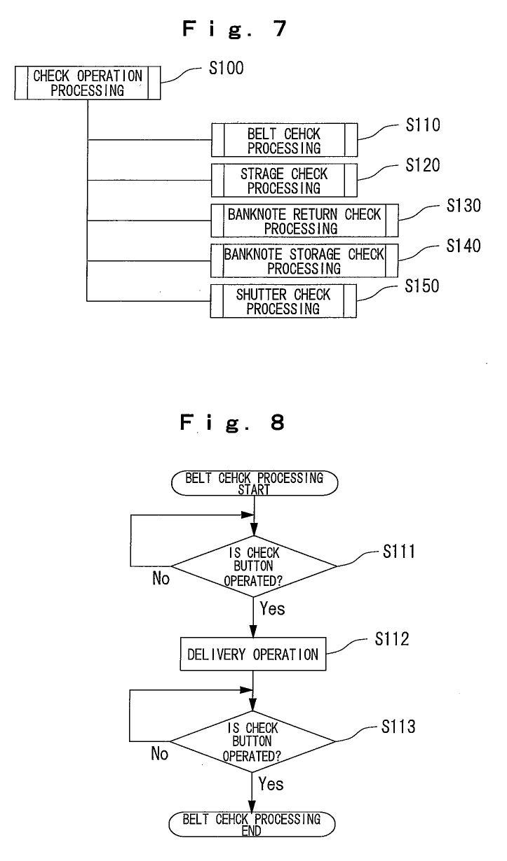

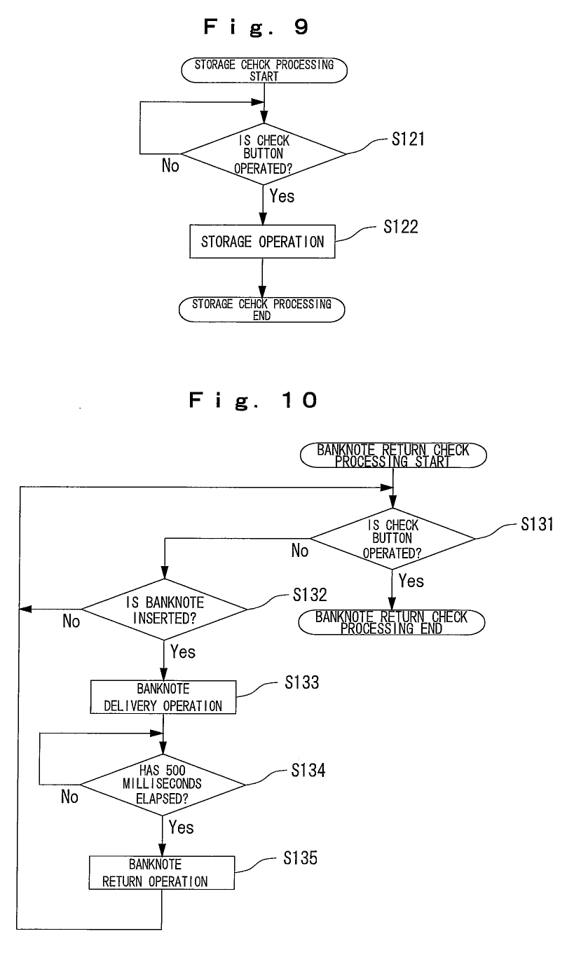

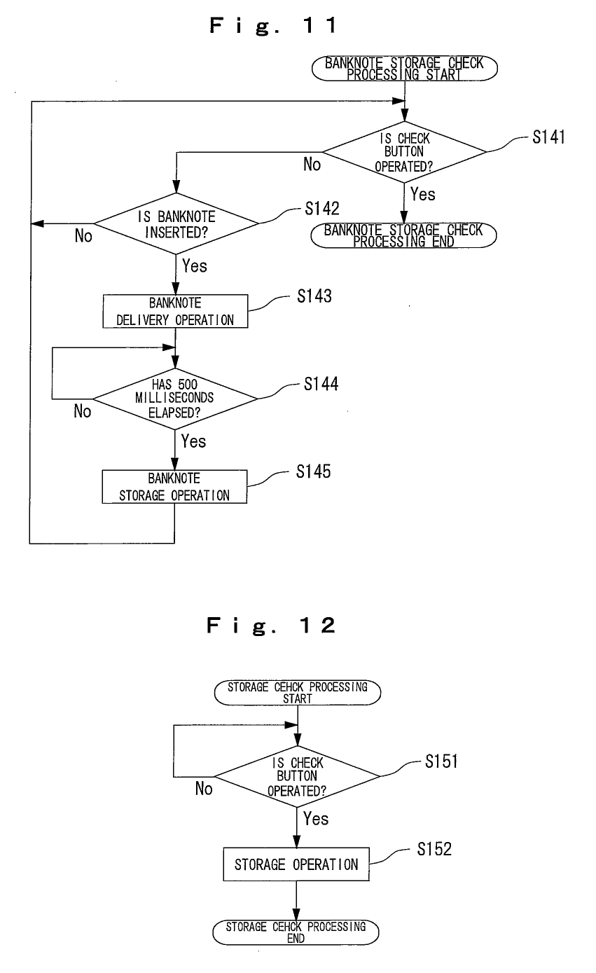

FIGS. 1 to 12 show one embodiment of the present invention, FIG. 1 is a front perspective view of a banknote identification apparatus; FIG. 2 is a rear perspective view of the banknote identification apparatus shown in FIG. 1; FIG. 3 is a side section view of the banknote identification apparatus shown in FIGS. 1 and 2; FIG. 4 is an enlarged view of a main part of FIG. 3; FIG. 5 is a diagram showing a control system for checking the banknote identification apparatus; FIG. 6 is a flow chart explaining actions for checking the banknote identification apparatus; FIG. 7 is a constitution view of the checking operation shown in FIG. 6; FIG. 8 is a flow chart explaining a belt checking processing shown in FIG. 7; FIG. 9 is a flow chart explaining an storage checking processing shown in FIG. 7; FIG. 10 is a flow chart explaining a banknote return checking processing shown in FIG. 7; FIG. 11 is a flow chart explaining banknote storage checking processing shown in FIG. 7; and FIG. 12 is a flow chart explaining a shutter checking processing shown in FIG. 7. In the following explanation, a front side of FIG. 1 is designated as a front, a back side is as a rear, a left side is as a left, and a right side is as a right.

First, with reference to FIGS. 1 to 4, the mechanism of the banknote identification apparatus will be explained.

The banknote identification apparatus shown in FIGS. 1 to 4 comprises a main frame 10, a base box 20, a front chute 30, a banknote delivery unit 40, a rear chute 50, a mask 60, and a banknote storage cassette 70.

The base box 20 is formed into a box shape with its top and rear faces opened, and the front face is fixed to a bottom of the rear face of the main frame 10. The base box 20 has a vertically-long rectangular banknote storage plate 21 for pushing a banknote PM (see FIG. 4) in the banknote storage cassette 70, a link mechanism 22 for parallely moving the banknote storage plate 21 back and forth, an storage drive source (not illustrated) having an storage motor (see numeral 122 of FIG. 5), a decelerating gear and a driving lever, journaling holes 23 for the rear chute provided on the right and the left on a top rear side in a manner that its centerline is directed to a rightward and leftward direction, and journaling holes 24 for the banknote storage cassette provided on the right and the left on a bottom rear side in a manner that its centerline is directed to the rightward and leftward direction.

The link mechanism 22 has a pair of right and left upper links 22a, whose top ends are rotatably connected with the banknote storage plate 21 and whose bottom ends are rotatably connected with the base box 20, a pair of right and left lower links 22b, whose top ends are rotatably connected with the base box 20 and whose bottom ends are rotatably connected with the banknote storage plate 21, and an operating shaft 22c common to the upper links 22a and the lower links 22b. A drive lever (not illustrated) is engaged with the operating shaft 22c, and the form of the link mechanism 22 varies as the drive lever (not illustrated) moves back and forth, so that the banknote storage plate 21 is moved back and forth in parallel.

The front chute 30 entirely has an approximately rectangular shape, and its front face is fixed to the top on the rear face of the main frame 10. The front chute 30 has a top curved part 31 extending backward, a bottom curved part 32 extending forward, four rollers 33 rotatably provided to the top, bottom, right and left having intervals and with one part thereof exposed to the rear side, a banknote delivery unit mounting part (not illustrated), and an insertion detecting sensor 34 provided with one part thereof exposed to the rear side.

One of the insertion detecting sensor 34 and a below-described insertion detecting sensor 44 is composed of a plurality of light emitting elements such as light emitting diodes, and the other is composed of a plurality of light receiving elements such as photodiodes and phototransistors. The light-receiving sensor among the insertion detecting sensors 34 and 44 outputs insertion detecting signals related to intensity change of the detected lights to a below-described check control unit 100 through a below-described detection unit 110.

Also, two right rollers 33 among the four rollers 33 correspond to front upper and lower positions of a right endless belt 43 of the banknote delivery unit 40, and their exposed parts come into contact with the endless belt 43. Two left rollers 33 correspond to front upper and lower positions of the left endless belt 43 of the banknote delivery unit 40, and their exposed parts come into contact with the endless belt 43.

The banknote delivery unit 40 entirely has an approximate rectangular parallelepiped shape, and is detachably fixed to a banknote delivery unit mounting part (not illustrated) of the front chute 30. The banknote delivery unit 40 has a unit body 41, pulleys 42 rotatably provided to the right and the left at the top of the unit body 41, pulleys 42 rotatably provided to the right and the left at the bottom of the unit body 41 through a common rotary shaft, two endless belts 43 wound around two left pulleys 42 and two right pulleys 42 to be opposed to each other at both sides in a width direction of the banknote PM, a driven gear (not illustrated) coaxially connected with the left lower pulley 42, an insertion detecting sensor 44 provided in the unit body 41 to be opposed to the insertion detecting sensor 34 with one part thereof exposed to a front side, and an authenticity identification sensor 47 provided in the unit body 41 with one part thereof exposed to a rear side.

One of the authenticity identification sensor 47 and a below-described authenticity identification sensor 53 is composed of a plurality of light emitting elements such as light emitting diodes, and the other is composed of a plurality of light receiving elements such as photodiodes and phototransistors. The light-receiving sensor among the authenticity identification sensor 47 and 53 outputs signals related to intensity change of the detected lights.

The rear chute 50 entirely has an approximately rectangular parallelepiped shape. The rear chute 50 has a curved part 51 extending forward, four rollers 52 rotatably provided to the top, bottom, right and left having intervals and with one part thereof exposed to the front side, an authenticity identification sensor 53 provided as opposed to the authenticity identification sensor 47 with one part thereof exposed to the front side, a delivery drive source (not illustrated) having a delivery motor (see numeral 121 of FIG. 5), a decelerating gear and a driving gear, a banknote detection lever 54 rotatably journalled and energized in a counterclockwise direction of FIG. 3 by a coil spring (not illustrated) in a manner that its tip projects forward from a vertically-long slit 50a and comes into contact with the rear face of the unit body 41, a passage detection sensor 55 which detects the movement of the banknote detection lever 54 as the banknote passes, supporting pieces 56 provided to the right and the left on the rear side of the bottom face, and shaft parts 56a provided to the respective supporting pieces 56 in a manner that their centerlines are directed to a rightward and leftward direction. The right and left shaft parts 56a of the rear chute 50 are rotatably inserted in the right and left journaling holes 23 of the base box 20, and the rear chute 50 is mounted to the base box 20 so that it can be opened and closed by a rotary action using the journalled portion as a fulcrum.

The passage detection sensor 55 is composed of combination of light emitting elements such as light emitting diodes and light receiving elements such as photodiodes and phototransistors. The light receiving elements of the passage detection sensor 55 outputs signals related to intensity change of the detected lights.

Also, two right rollers 52 among the four rollers 52 correspond to rear upper and lower positions of a right endless belt 43 of the banknote delivery unit 40, and their exposed parts come into contact with the endless belt 43. Two left rollers 52 correspond to rear upper and lower positions of the left endless belt 43 of the banknote delivery unit 40, and their exposed parts come into contact with the endless belt 43. As seen from FIGS. 3 and 4, the two right and left lower rollers 52 are rotatably provided to a projection piece 50b, and their respective centerlines are positioned at height approximately same as that of the centerlines of the two right and left lower pulleys 42.

A drive gear (not illustrated) of the delivery drive source is meshed with a driven gear (not illustrated) of the banknote delivery unit 40 while the rear chute 50 is closed. That is to say, each of the endless belts 43 of the banknote delivery unit 40 rotates in a predetermined direction based on a rotary force transmitted from the drive gear (not illustrated) of the delivery drive source to the driven gear (not illustrated), and delivers the banknote.

A mask 60 has a box shape with its rear face opened, and the rear face is fixed to a front face of the main frame 10. The mask 60 has a laterally-long banknote insertion slot 61 from the front face to the rear face, and a curved part 62 extending backward from the bottom of the rear end of the banknote insertion slot 61.

A banknote storage cassette 70 has a box shape with a top face and a bottom face opened. The banknote storage cassette 70 has vertically-long rails 71 provided to the right and the left of a front opening, vertically-long rectangular cassette plates 72 having a width from the right to the left slightly larger than the interval from the right to the left between both rails 71 and arranged to rear sides of the both of the rails 71, a truncated-cone-like coil spring 73 energizing the cassette plates 72 forward, a hook lever (not illustrated) for mounting and dismounting the banknote storage cassette 70 in the base box 20, a notch 74 for operating the hook lever (not illustrated) from the rear face side, supporting pieces 75 provided to the right and the left on the rear side of the bottom face, and shaft parts 75a provided to the respective supporting pieces 75 in a manner that their centerlines are directed to a rightward and leftward direction. The right and left shaft parts 75a of the banknote storage cassette 70 are inserted in the right and left journaling holes 24 of the base box 20, and the banknote storage cassette is dismounted from the base unit 20 by the operation of the hook lever (not illustrated) into a rotatable condition, and is mounted to the base box 20 so that it can be opened and closed by the rotary action using the journalled portion as a fulcrum.

In the above-mentioned banknote identification apparatus, when the rear chute 50 is at a closed position, the banknote delivery unit 40 is made into a condition that the front and rear parts thereof are sandwiched between the front chute 30 and the rear chute 50. Also, because of the top curved part 31 and the curved part 51, an inverted U-shaped banknote passage BP (see FIG. 4) including boundaries between the respective endless belts 43 and the respective rollers 33, 52 is formed around the banknote delivery unit 40. The front bottom end of the banknote passage BP is communicated with the rear end of the banknote insertion slot 61 via the curved part 62 of the mask 60. Accordingly, when the rear chute 50 is at a closed position, the banknote delivery unit 40 and the banknote passage BP are covered. Also, a shutter (see numeral 123 of FIG. 5) is provided in the middle portion of the banknote passage BP, and the shutter 123 opens and closes the banknote passage BP and is arranged at a visible position while the rear chute 50 is opened.

Now, with reference to FIG. 5, a control system for checking the banknote identification apparatus will be explained.

The control system shown in FIG. 5 comprises a check control unit 100, a detection unit 110, selection switches 111, 112, 113, a check button 114, the above-mentioned insertion detecting sensors 34, 44, a rear chute opening/closing detection sensor 115, an storage cassette opening/closing detection sensor 116, a drive unit 120, a delivery motor 121 of the above-mentioned delivery drive source (not illustrated), an storage motor 122 of the above-mentioned storage drive source (not illustrated), and the above-mentioned shutter 123.

The check control unit 100 controls the operations for checking the banknote identification apparatus, and is connected with the detection unit 110 and the drive unit 120. Also, the check control unit 100 is composed of a well-known computer with a CPU and memories such as RAMs and ROMs, and outputs drive signals to the drive unit 120 based on a program and data stored in its own memory and detection signals input from the detection unit 110.

The selection switches 111, 112, 113, the check button 114, the above-mentioned insertion detecting sensors 34, 44, the rear chute opening/closing detection sensor 115, and the storage cassette opening/closing detection sensor 116 are connected with the detection unit 110, and the detection unit 110 outputs the respective input detection signals to the check control unit 100.

The selection switches 111, 112, 113 comprise well-known dip switches, and can be switched on or off, respectively. When the switches are turned on, they output ON-signals, respectively.

The check button 114 comprises a well-known tact switch, and outputs ON-signals while the check button 114 is pressed.

The rear chute opening/closing detection sensor 115 detects the opened/closed condition of the rear chute 50, and outputs opening signals while the rear chute 50 is opened. Also, the rear chute opening/closing detection sensor may be provided separately from other sensors as in this embodiment, or the authenticity identification sensors 47, 53 or the banknote detection lever 54 may be commonly used.

The storage cassette opening/closing detection sensor 116 detects the opened/closed condition of the banknote storage cassette 70, and outputs opening signals while the banknote storage cassette 70 is opened by operating the hook lever (not illustrated) from the notch 74.

The delivery motor 121 of the above-mentioned delivery drive source (not illustrated), the storage motor 122 of the above-mentioned storage drive source (not illustrated), and the above-mentioned shutter 123 are connected with the drive unit 120, and the drive unit 120 outputs drive signals input from the check control unit 100 to the delivery motor 121, the storage motor 122, and the shutter 123, respectively.

Now, with reference to FIGS. 6 to 12, the operations for checking the banknote identification apparatus will be explained.

As shown in FIG. 6, the check control unit 100 judges whether a check operator operates the hook lever (not illustrated) from the notch 74 and the banknote storage cassette 70 is opened or not based on the opening signals input from the storage cassette opening/closing detection sensor 116 via the detection unit 110 (step S11), and the processing in the step S11 is repeated until the banknote storage cassette 70 is opened.

When the banknote storage cassette 70 is opened, i.e., when the opening signals are input from the storage cassette opening/closing detection sensor 116 via the detection unit 110, the check control unit 100 judges whether the check operator presses the check button 114 for 3 seconds or more based on the ON-signals input from the check button 114 via the detection unit 110 and its own time-watch function (step S12).

When the check button 114 is being pressed for 3 seconds or more, i.e., when the ON-signals input from the check button 114 via the detection unit 110 continue for 3 seconds or more, the check control unit 100 judges whether the check button 114 being pressed by the check operator is released or not based on the ON-signals input from the check button 114 via the detection unit 110 (step S13), and the processing in the step S13 is repeated until the pressed check button 114 is released.

When the check button 114 being pressed by the check operator is released, i.e., when the ON-signals being input from the check button 114 via the detection unit 110 are not input any more, the check control unit 100 identifies authenticity of the inserted banknote PM, and is shifted from a normal mode for storing the banknote in the banknote storage cassette 70 to a check mode, in which a predetermined check operation can be done (step S14). Thereby, it is judged whether the predetermined check operation can be done or not.

Then, the check control unit 100 judges whether the check operator keeps the banknote storage cassette 70 opened or not based on the opening signals input from the storage cassette opening/closing detection sensor 116 via the detection unit 110 (step S15).

When the banknote storage cassette 70 remains opened, the check control unit 100 judges whether the check operator presses the check button 114 and then releases it or not (hereinafter, referred to as the operation of the check button) based on the ON-signals input from the check button 114 via the detection unit 110 (step S16), and the processing in the step S16 is repeated until the check button 114 is operated.

When the check button 114 is operated, i.e., when the ON-signals are input from the check button 114 via the detection unit 110 and thereafter the ON-signals are not input any more, the check control unit 100 executes a below-described check operation processing S100, in which the banknote identification apparatus is made to execute a predetermined check operation.

After executing the below-described check operation processing S100, the check control unit 100 repeats the processing in steps S15 to S100.

As a result of judgment in the step S12, when the check button 114 is not being pressed for 3 seconds or more, i.e., when the ON-signals input from the check button 114 via the detection unit 110 continues for not more than 3 seconds, or when the opening signals are not input from the check button 114, the check control unit 100 repeats the processing in the steps S11 to S12.

As a result of judgment in the step S15, when the banknote storage cassette 70 is closed, i.e., when the opening signals being input from the storage cassette opening/closing detection sensor 116 via the detection unit 110 are not input any more, the check control unit 100 is returned to the normal mode from the check mode, and the processing in the steps S11 to S15 is repeated again. Thereby, based on a result of detection by the storage cassette opening/closing detection sensor 116, it is judged whether the mode is shifted to the check mode, in which a predetermined check action can be done, or not.

In this embodiment, whether the banknote storage cassette 70 is opened or not is judged and the mode is shifted to the check mode or returned to the normal mode. The present invention is not limited to this, and the mode may be shifted to the check mode or returned to the normal mode based on other conditions.

Here, the check operation processing S100 executed when the check button 114 is operated as a result of judgment in the step S16 will be explained.

As shown in FIG. 7, the check operation processing S100 comprises a belt check processing S110 for a delivery operation, an storage check processing S120 for an storage operation, a banknote return check processing S130 for a banknote return action, a banknote storage check processing S140 for a banknote storage action, and a shutter check processing S150 for a shutter operation.

The check control unit 100 selects and executes the processing based on the respective ON-signals input from the selection switches 111, 112, 113 via the detection unit 110 and the opening signals input from the rear chute opening/closing detection sensor 115 via the detection unit 110. In this manner, one check operation is selected from predetermined check operations, and therefore, the check operation is done which is selected when it is judges that the predetermined check operation can be done.

In this embodiment, the check control unit 100 executes the belt check processing S110 when the selection switch 111 is turned on, the selection switches 112 and 113 are turned off and the rear chute 50 is closed, executes the storage check processing S120 when the selection switch 112 is turned on, the selection switches 111 and 113 are turned off and the rear chute 50 is closed, executes the banknote return check processing S130 when the selection switch 113 is turned on, the selection switches 111 and 112 are turned off and the rear chute 50 is closed, executes the banknote storage check processing S140 when the selection switches 111, 112 and 113 are turned off and the rear chute 50 is closed, and executes the shutter check processing S150 when the selection switches 111, 112 and 113 are turned off and the rear chute 50 is opened. Thereby, one check operation is selected from predetermined check operations based on the detection result of the rear chute opening/closing detection sensor 115.

As shown in FIG. 8, when the belt check processing S110 is started, the check control unit 100 judges whether the check operator operates the check button 114 or not based on the ON-signals input from the check button 114 via the detection unit 110 (step S111), and the processing in the step S111 is repeated until the check button 114 is operated.

When the check button 114 is operated, i.e., the ON-signals are input from the check button 114 via the detection unit 110 and thereafter the ON-signals are not input any more, the check control unit 100 outputs the drive signals to the delivery motor 121 via the drive unit 120 for executing the delivery operation (step S112). Thereby, the delivery operation is done based on the operation of the check button 114.

In this embodiment, when the check button 114 is operated, the delivery operation is done. However, the present invention is not limited to this, and the delivery operation may be done when the check button 114 is pressed.

Here, the delivery operation refers to a condition that the delivery motor 121 rotates and thereby each of the endless belts 43 of the banknote delivery unit 40 rotates. Therefore, the check operator can verify the operation of each of the endless belts 43.

After completion of the delivery operation, the check control unit 100 judges whether the check operator operates the check button 114 again or not based on the ON-signals input from the check button 114 via the detection unit 110 (step S113). The processing in the step S111 is repeated until the check button 114 is operated, and the belt check processing S110 is completed when the check button 114 is operated.

Also, when abnormality is detected in the course of the delivery operation, it is desirable that the delivery operation is paused and the belt check processing S110 is completed.

Also, as shown in FIG. 9, when the storage check processing S120 is started, the check control unit 100 judges whether the check operator operates the check button 114 or not based on the ON-signals input from the check button 114 via the detection unit 110 (step S121), and the processing in the step S121 is repeated until the check button 114 is operated.

When the check button 114 is operated, i.e., the ON-signals are input from the check button 114 via the detection unit 110 and thereafter the ON-signals are not input any more, the check control unit 100 outputs the drive signals to the storage motor 122 via the drive unit 120 for executing the storage operation (step S122). Thereby, the storage operation is done based on the operation of the check button 114.

In this embodiment, when the check button 114 is operated, the storage operation is done. However, the present invention is not limited to this, and the storage operation may be done when the check button 114 is pressed.

Here, the storage operation refers to a condition that the storage motor 122 rotates and thereby the form of the link mechanism 22 varies, the banknote storage plate 21 parallely moves leftward, the cassette plate 72 is pushed in the banknote storage cassette 70 in a manner that it is pushed away against an energizing force of the coil spring 73, the storage motor 122 further rotates after pushed in, and the link mechanism 22 and the banknote storage plate 21 are returned to their original positions. Therefore, the check operator can recognize the operations of the banknote storage plate 21 and the link mechanism 22.

After completion of the storage operation in the step S122, the check control unit 100 completes the storage check processing S120.

Also, when abnormality is detected in the course of the storage operation, it is desirable that the storage operation is paused and the storage check processing S120 is completed.

Also, as shown in FIG. 10, when the banknote return check processing S130 is started, the check control unit 100 judges whether the check operator operates the check button 114 or not based on the ON-signals input from the check button 114 via the detection unit 110 (step S131), and the check control unit 100 completes the banknote return check processing S130 when the check button 114 is operated.

When the check button 114 is not operated, i.e., the ON-signals are not input from the check button 114 via the detection unit 110, the check control unit 100 judges whether the check operator inserts the banknote PM from the banknote insertion slot 61 based on the insertion detecting signals input from the insertion detecting sensors 34, 44 via the detection unit 110 (step S132).

When the banknote PM is inserted from the banknote insertion slot 61, i.e., when the insertion detection signals are input from the insertion detecting sensors 34, 44 via the detection unit 110, the check control unit 100 outputs the drive signals to the delivery motor 121 via the drive unit 120 for executing the banknote delivery operation (step S133). Thereby, a below-described banknote return operation is done based on the detection results of the insertion detecting sensors 34, 44 and the operation of the check button 114.

In this embodiment, a below-described banknote return operation is done by judging whether the check button 114 is operated or not and whether the banknote PM is inserted from the banknote insertion slot 61 or not. However, the present invention is not limited to this, and a below-described banknote return operation may be done by judging whether the banknote PM is inserted from the banknote insertion slot 61 or not. Thereby, a below-described banknote return operation is done based on the detection results of the insertion detecting sensors 34 and 44.

Here, the banknote delivery operation refers to a condition that the delivery motor 121 rotates and thereby each of the endless belts 43 of the banknote delivery unit 40 rotates and the inserted banknote PM is delivered to a predetermined position.

After completion of the banknote delivery operation, the check control unit 100 judges whether 500 milliseconds has elapsed or not from the completion of the banknote delivery operation based on its own time-watch function (step S134), and the processing in the step S134 is repeated until 500 milliseconds has elapsed from the completion of the banknote delivery operation.

When 500 milliseconds has elapsed from the completion of the banknote delivery operation, the check control unit 100 outputs the drive signals to the delivery motor 121 via the drive unit 120 for executing the banknote return operation (step S135).

Here, the banknote return operation refers to a condition that the delivery motor 121 rotates in an opposite direction and thereby each of the endless belts 43 of the banknote delivery unit 40 rotates in the opposite direction and the banknote PM located at the predetermined position is delivered and returned toward the banknote insertion slot 61. Thereby, the check operator can recognize the operation that the banknote delivery unit 40 and the front and rear rollers 33, 52 deliver and return the banknote PM.

As a result of judgment in the step S132, when the banknote PM is not inserted from the banknote insertion slot 61, i.e., when the insertion detection signals are not input from the insertion detecting sensors 34, 44 via the detection unit 110, the check control unit 100 repeats the processing of the steps S131 to S132.

After completion of the banknote return operation in the step S135, the check control unit 100 repeats the processing in the steps S131 to S135.

Also, when abnormality is detected in the course of the banknote delivery or return operation, it is desirable that the banknote delivery or return operation is paused and the banknote return check processing S130 is completed.

Also, as shown in FIG. 11, steps S141 to S144 in the banknote storage check processing S140 are similar to the steps S131 to S134 in the above-mentioned banknote return check processing S130, and therefore, explanation thereof will be omitted.

As a result of judgment in the step S144, when 500 milliseconds has elapsed from the completion of the banknote delivery operation, the check control unit 100 outputs the drive signals to the delivery motor 121 via the drive unit 120 for executing the banknote storage operation (step S145).

Here, the banknote storage operation refers to a condition that the storage motor 122 rotates and thereby the form of the link mechanism 22 varies, the banknote storage plate 21 parallely moves leftward, the banknote PM existing at the predetermined position moves leftward together with the banknote storage plate 21, the cassette plate 72 is pushed in the banknote storage cassette 70 in a manner that it is pushed away against an energizing force of the coil spring 73, the storage motor 122 further rotates after pushed in, the link mechanism 22 and the banknote storage plate 21 are returned to their original positions, and the banknote PM moves leftward together with the banknote storage plate 21 and is pushed in the banknote storage cassette 70. Therefore, the check operator can recognize the operation that the banknote storage plate 21 and the link mechanism 22 stores the banknote PM in the banknote storage cassette 70.

After completion of the banknote storage operation in the step S145, the check control unit 100 repeats the processing in the steps S141 to S145.

Also, when abnormality is detected in the course of the banknote delivery or storage operation, it is desirable that the banknote delivery or storage operation is paused and the banknote storage check processing S140 is completed.

Also, as shown in FIG. 12, a step S151 in the shutter check processing S150 is similar to the step S121 in the above-mentioned storage check processing S120, and therefore, explanation thereof will be omitted.

As a result of judgment in the step S151, when the check button 114 is operated, i.e., when the ON-signals are input from the check button 114 via the detection unit 110 and thereafter the ON-signals are not input any more, the check control unit 100 outputs the drive signals to the shutter 123 via the drive unit 120 for executing the shutter operation (step S152).

Here, the shutter operation refers to a condition that the shutter 123, which opens the banknote passage BP, is driven and the banknote passage BP is closed. Thereby, the check operator can check the operation that the shutter 123 opens and closes the banknote passage.

After completion of the shutter operation in the step S152, the check control unit 100 completes the shutter check processing S150.

Also, when abnormality is detected in the course of the shutter operation, it is desirable that the shutter operation is paused and the shutter check processing S150 is completed.

In this manner, according to the present invention, it is judged whether predetermined check operations can be done or not and one check operation is selected from the predetermined check operations, so that the selected check operation is made to be done when it is judges that the predetermined check operations can be done. Therefore, there is no need of other machines in the check operation and the selected check operation can be done. Therefore, the arbitrarily selected check operation can be verified, and the check operation can be made easily.

Also, because it is judged whether predetermined check operations can be done or not based on the detection result of the storage cassette opening/closing detection sensor 116, possibility that it is judged that the predetermined check operations can be done by a malfunction can be reduced, and the check operation can be surely done.

Also, because the check operation is done based on at least one of the turn-on and turn-off of the check button 114, possibility that the check operation selected by a wrong operation is done can be reduced, and the check operation can be surely done.

Also, because the banknote return or storage operation is done based on the detection results of the insertion detecting sensors 34 and 44, the banknote return or storage operation is not done when the banknote PM is not inserted from the banknote insertion slot 61. Therefore, possibility that the banknote return or storage operation is done by a wrong operation can be reduced, and the check operation of the banknote return or storage operation can be surely done.

Additionally, because the banknote return or storage operation is done based on the detection results of the insertion detecting sensors 34 and 44 and at least one of the turn-on and turn-off of the check button 114, the banknote return or storage operation is not done when the banknote PM is not inserted from the banknote insertion slot 61. Therefore, possibility that the banknote return or storage operation is done by a wrong operation can be reduced, and the check operation of the banknote return or storage operation can be done more surely.

Also, because one check operation is selected from predetermined check operations based on the detection result of the rear chute opening/closing detection sensor 115, the shutter operation is not selected when the rear chute 50 is closed. Therefore, possibility that the shutter operation is done by a wrong operation or a malfunction can be reduced, and the check operation of the shutter operation can be done more surely.

Judgment that the predetermined check operations can be done by a malfunction is reduced, and therefore, the check operation can be surely done.

The embodiments described herein are illustrative, and do not limit the invention. The scope of the invention is defined by the accompanying claims, and all of variations included in the sense of these claims shall be encompassed by the present invention.

1. A banknote identification apparatus comprising
a banknote delivery mechanism which delivers banknotes inserted in a banknote insertion slot,
a banknote identification mechanism for judging authenticity of the banknotes,
a unit body including at least the banknote delivery mechanism and the banknote identification mechanism,
a banknote storage cassette for storing the banknotes delivered by the banknote delivery mechanism,
a judgment means for judging whether predetermined checking operations can be done or not,
a selection means for selecting one of the checking operation among the predetermined checking operations, and
a check means for performing the check operation selected by the selection means when it is judged that said predetermined checking operations can be done by the judgment means.

2. The banknote identification apparatus described in claim 1, comprising a cassette opening/closing detection means for detecting opening/closing the banknote storage cassette which is openably provided, wherein the judgment means judges whether said predetermined checking operations can be done or not based on a detection result of the cassette opening/closing detection means.

3. The banknote identification apparatus described in claim 1, comprising a check button which can execute a check operation selected by the selection means, wherein the check means executes the check operation selected by the selection means based on at least one of turn-on and turn-off of the check button when it is judged that said predetermined checking operations can be done by the judgment means.

4. The banknote identification apparatus described in claim 1, comprising a insertion detection means for detecting whether a banknote is inserted in a banknote insertion slot or not, wherein the check means executes the check operation selected by the selection means based on a detection result of the insertion detection means when it is judged that said predetermined checking operations can be done by the judgment means.

5. The banknote identification apparatus described in claim 1, comprising a unit body opening/closing detection means for detecting opening/closing of the unit body openably provided, wherein the selection means selects one check operation from said predetermined check operations based on a detection result of the unit body opening/closing detection means.

6. The banknote identification apparatus described in claim 2, comprising a check button which can execute a check operation selected by the selection means, wherein the check means executes the check operation selected by the selection means based on at least one of turn-on and turn-off of the check button when it is judged that said predetermined checking operations can be done by the judgment means.

7. The banknote identification apparatus described in claim 2, comprising a insertion detection means for detecting whether a banknote is inserted in a banknote insertion slot or not, wherein the check means executes the check operation selected by the selection means based on a detection result of the insertion detection means when it is judged that said predetermined checking operations can be done by the judgment means.

8. The banknote identification apparatus described in claim 2, comprising a unit body opening/closing detection means for detecting opening/closing of the unit body openably provided, wherein the selection means selects one check operation from said predetermined check operations based on a detection result of the unit body opening/closing detection means.

9. The banknote identification apparatus described in claim 3, comprising a insertion detection means for detecting whether a banknote is inserted in a banknote insertion slot or not, wherein the check means executes the check operation selected by the selection means based on the detection result by the insertion detection means and at least one of turn-on and turn-off of the check button when it is judged that said predetermined checking operations can be done by the judgment means.

10. The banknote identification apparatus described in claim 3, comprising a unit body opening/closing detection means for detecting opening/closing of the unit body openably provided, wherein the selection means selects one check operation from said predetermined check operations based on a detection result by the unit body opening/closing detection means.

11. The banknote identification apparatus described in claim 4, comprising a unit body opening/closing detection means for detecting opening/closing of the unit body openably provided, wherein the selection means selects one check operation from said predetermined check operations based on a detection result by the unit body opening/closing detection means.

12. The banknote identification apparatus described in claim 6, comprising a unit body opening/closing detection means for detecting opening/closing of the unit body openably provided, wherein the selection means selects one check operation from said predetermined check operations based on a detection result by the unit body opening/closing detection means.

13. The banknote identification apparatus described in claim 7, comprising a unit body opening/closing detection means for detecting opening/closing of the unit body openably provided, wherein the selection means selects one check operation from said predetermined check operations based on a detection result by the unit body opening/closing detection means.

14. The banknote identification apparatus described in claim 9, comprising a unit body opening/closing detection means for detecting opening/closing of the unit body openably provided, wherein the selection means selects one check operation from said predetermined check operations based on a detection result of the unit body opening/closing detection means.
